(19) United States
(12) Patent Application Publication
(10) Pub. No.: US 2012/0005839 A1
(43) Pub. Date: Jan. 12, 2012

(54) GENTLE BLEACHING AGENT

(75) Inventors: Anette Nordskog, Sandefjord (NO); Siglinde Erpenbach, Monheim (DE); Dorota Sendor-Müller, Dusseldorf (DE); Peter Schmiedel, Dusseldorf (DE); Wolfgang von Rybinski, Dusseldorf (DE); Ursula Huchel, Koln (DE); Birgit Middelhauve, Monheim (DE); Thomas Weber, Dormagen (DE)

(73) Assignee: Henkel AG & Co. KGaA, Dusseldorf (DE)

(21) Appl. No.: 13/239,650

(22) Filed: Sep. 22, 2011

Related U.S. Application Data
(63) Continuation of application No. PCT/EP2010/053080, filed on Mar. 11, 2010.

(30) Foreign Application Priority Data
Mar. 24, 2009 (DE) 10 2009 001 788.7

(51) Int. Cl. D06L 3/02; C11D 3/60

(52) U.S. Cl. 8/111; 510/311

(57) ABSTRACT

An agent, and a method that uses the agent, reduces the damage to material containing cellulose during the bleaching thereof, by using a bleaching agent containing peroxygen, a bleach-enhancing transition metal complex, and creatine.

### CROSS-REFERENCES TO RELATED APPLICATIONS

This application is a continuation of PCT/EP2010/053080, filed on Mar. 11, 2010, which claims priority under 35 U.S.C. §119 to DE 10 2009 001 788.7 filed on Mar. 24, 2009, both of which are hereby incorporated by reference.

### FIELD OF THE INVENTION

The present invention generally relates to the treatment of material containing cellulose, and more particularly relates to the treatment of such material in the presence of a bleaching agent and a bleach-activating agent.

### BACKGROUND OF THE INVENTION

Inorganic peroxygen compounds, in particular hydrogen peroxide and solid peroxygen compounds, which dissolve in water, releasing hydrogen peroxide, such as sodium perborate and sodium carbonate perhydrate, have long been used as oxidizing agents for disinfection and bleaching purposes. The oxidizing effect of these substances in dilute solutions depends greatly on the temperature. For example, with H₂O₂ or perborate in alkaline bleaching solutions, a sufficiently rapid bleaching of soiled textiles is achieved only at temperatures above approx. 80° C. At lower temperatures, the oxidation effect of the inorganic peroxygen compounds can be improved by adding so-called bleach activators, for which numerous proposals have become known in the literature, especially from the substance classes of N- or O-acyl compounds, for example, polyacylated alkylenediamines, in particular tetraacetylethylene-diamine, acylated glycol urils, in particular tetraacetylglycol uril, N-acylated hydantoins, hydrazides, triazoles, hydrotriazines, urazoles, diketopiperazines, sulfurylamides and cyanurate, also carboxylic anhydrides, in particular phthalic anhydride, carboxylic acid esters, in particular sodium nonanoyloxybenzene sulfonate, sodium isononanoyloxybenzene sulfonate and acylated sugar derivatives such as pentaacetylglucose. By adding these substances, the bleaching effect of aqueous peroxide solutions can be increased to such an extent that essentially the same effects occur even at temperatures around 60° C. as with the peroxide bath alone at 95° C. Damage to the tissue remains within an acceptable framework for the user.

In an effort to develop energy-saving washing and bleaching methods, use temperatures definitely below 60° C., in particular less than 45° C. down to the temperature of cold water have become increasingly important in recent years.

At these low temperatures, the effect of the activator compounds known in the past usually declines perceptibly. Therefore there has been no lack of attempts to develop more effective bleach systems for this temperature range. One approach is obtained by using compounds which supply hydrogen peroxide together with transition metal salts and complexes as so-called bleaching catalysts. With these catalysts, however, there is the risk of oxidative damage to the textile presumably because of the high reactivity of the oxidizing intermediates formed from them and the peroxygen compound. The use of such transition metal catalysts in washing agents has previously been made difficult in practice because then the damage to the tissue is much higher than that with a conventional peracid-forming system of bleaching agent and bleach activator. The same thing is logically also true of bleaching processes performed in the production of materials containing cellulose such as pulp or paper.

Accordingly, it is desirable to reduce the damage to the material containing cellulose, for example, a textile containing cotton with the use of bleaching catalysts in bleaching treatment of material containing cellulose, for example, in washing textiles containing cotton, without significantly influencing the bleaching performance.

Furthermore, other desirable features and characteristics of the present invention will become apparent from the subsequent detailed description of the invention and the appended claims, taken in conjunction with the background of the invention.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

In a first aspect, the subject matter of the invention is a method for bleaching treatment of material containing cellulose, in particular the production of pulp or paper or in washing textiles containing cotton in the presence of a peroxygen-containing bleaching agent and a bleach-activating transition metal complex, which is characterized in that it is performed in the presence of creatine.

Creatine is a glycine derivative of formula (I):

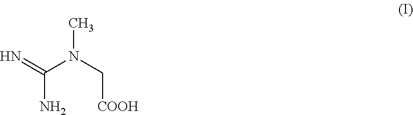

which may be anhydrous or used in the form of its hydrates. In a preferred form of the invention, the carboxyl group may be in salt form, in particular as an alkali salt such as a sodium salt or potassium salt.

Bleach-activating transition metal complex compounds that may be used include in particular those of the metals Fe, Mn, Co, V, RU, Ti, Mo, W, Cu and/or Cr, for example, manganese, iron, cobalt, ruthenium or molybdenum-salene complexes, manganese, iron, cobalt, ruthenium or molybdenum-carbonyl complexes, manganese, iron, cobalt, ruthenium, molybdenum, titanium, vanadium and copper complexes with nitrogen-containing tripod ligands, cobalt, iron, copper and ruthenium-ammine complexes and iron or manganese complexes with polyazacycloalkane ligands such as TACN.

The preferred bleach-activating transition metal complex compounds include metal complexes of formula (II)

[LₙMₘXₚ]^{z}Y_{q} (II)

where M denotes manganese or iron or mixtures of these metals, which may be present in oxidation states II, III, IV or V, or mixtures of same, n and m independently of one another are integers with a value of 1 to 4, X is a coordinating or bridging species, p is an integer with a value of 0 to 12, Y is a counterion, the type of which depends on the charge z of the complex, which may be positive, zero or negative, q=z/[charge Y], and L is a ligand, which is a macrocyclic organic molecule of the general formula

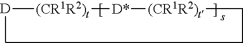

in which each of the radicals are R¹ and R² is zero, H, alkyl or aryl, optionally substituted; t and t′, independently of one another, are 2 or 3; D and D¹ independently of one another are N, NR, PR, O or S, wherein R is H, alkyl or aryl, optionally substituted, and S is an integer with a value of 2 to 5, wherein if D=N, then a heterocarbon bond attached thereto is unsaturated, which leads to the creation of an N═CR¹ fragment. The preferred metal M is manganese. The coordinating or bridging species X is preferably a small coordinating ion or bridging molecule or a mixture of same, for example, water, OH⁻, O²⁻, S²⁻, S(═O), N³, HOO, O₂²⁻, O₂−, amine, Cl⁻, SCN⁻, N₃⁻, and carboxylate, for example, acetate or mixtures thereof. If the charge z is positive, then Y is an anion, for example, chloride, bromide, iodide, nitrate, perchlorate, rhodanide, hexafluoro-phosphate, sulfate, alkyl sulfate, alkyl sulfonate or acetate; if the charge z is negative, Y is a cation, for example, an alkali ion, ammonium, ion or an alkaline earth ion. The preferred ligands L include 1,4,7-triazacyclononane, 1,4,7-trimethyl-1,4,7-triazacyclononane, 1,5,9-trimethyl-1,5,9-triazacyclododecane and 1,2,4,7 tetramethyl-1,4,7-triazacyclononane.

In another preferred embodiment, the bleach-activating transition metal complex compound corresponds to general formula (III)

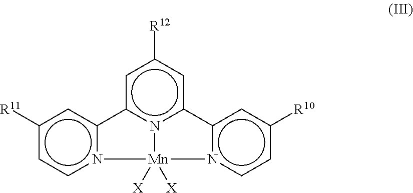

in which R¹⁰ and R¹¹ independently of one another stand for hydrogen, a C₁₋₁₈ alkyl group, a group NR¹³R¹⁴, a group N⁺R¹³R¹⁴R¹⁵ or a group

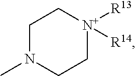

R¹² stands for hydrogen, OH or a C₁₋₁₈ alkyl group, R¹³, R¹⁴ and R¹⁵ independently of one another stand for hydrogen, a C₁₋₄ alkyl or hydroxyalkyl group and X stands for halogen and A stands for a charge equalizing anion ligand which depending on its charge and the type and number of other charges in particular the charge of the manganese central atom may also be absent or may be present several times. Manganese may have oxidation stages II, III, IV or V therein as well as in the complexes according to formula (II). If desired, although less preferred, other transition metals, for example, Fe, Co, Ni, V, RU, Ti, Mo, W, Cu and/or Cr may also be present instead of the Mn central atom in such complex compounds.

The inventive method may if desired be carried out at temperatures in the range of 10° C. to 95° C. The temperature is preferably in the range of 20° C. to 40° C.

The inventive method may if desired be performed at a pH in the weakly acidic to alkaline range in particular in the range of pH 7 to pH 12, preferably pH 9 to pH 11.

In an inventive method, concentrations of 0.001 g/L to 50 g/L in particular 0.01 g/L to 25 g/L creatine is used in the aqueous treatment solution.

In an inventive textile washing method, preferred peroxygen concentrations (calculated as H₂O₂) in the wash solution are in the range of 0.001 g/L to 10 g/L, in particular 0.1 g/L to 1 g/L. The concentration of bleach-activating transition metal complex in the wash solution is preferably in the range of 0.1 μmol to 50 μmol/L in particular 0.5 μmol/L to 10 μmol/L.

The inventive method can be implemented, for example, by adding peroxygen-containing bleaching agent, bleach-activating transition metal complex and the creatine each separately to a treatment solution for material containing cellulose, for example, a washing solution which may contain a conventional washing agent. It is also possible not to use the finished bleach-activating transition metal complex but instead to use separately one or more ligands which may form a bleach-activating transition metal complex in the process with a transition metal in situ; the transition metal may then also be added separately in the form of a salt or non-bleach-activating complex or it is added as a component of the process water used for the process or introduced into the process via the material containing cellulose to be treated in the case of textiles to be cleaned, for example, as a component of the soil to be removed. It is possible or preferable here to introduce the bleach-activating transition metal complex and the creatine simultaneously, in particular as a premix, preferably containing water, and/or present in the form of an aqueous solution.

A second subject matter of the invention is the use of creatine to minimize damage to material containing cellulose, for example, textiles containing cotton, due to the presence of bleach-activating transition metal complexes in the bleaching treatment of material containing cellulose, for example, in washing textiles.

In another preferred embodiment of the invention, an agent containing a peroxygen-containing bleaching agent, bleach-activating transition metal complex or a ligand which may form a bleach-activating transition metal complex in situ with a transition metal in the process and creatine. Such a washing agent which is gentle to textiles is another subject matter of the invention.

Inventive washing agents, which are present in solid form or as liquids or pastes, may be used as such in machine or manual washing processes but may also be used as washing agent additives and/or as washing and/or textile pretreatment agents.

Inventive agents together with a conventional washing agent are used as the washing agent additive. This is appropriate in particular when the user wants to improve the bleaching performance of the usual washing agent. In the wash pretreatment the inventive agents are used to improve the removal of encrusted dirt or spots in particular “problem spots,” such as coffee, tea, red wine, grass or fruit juice which are difficult to remove by washing with usual textile washing agents but are accessible to an oxidative attack. Another area for use of such agents is to remove local soiling from otherwise clean surfaces so that a more complex washing or cleaning process of the corresponding overall structure, whether a clothing item or a carpet or a furniture upholstery part can be avoided. To do so, one may apply an inventive agent optionally together with an amount of water which is not sufficient to completely dissolve the agent to the textile surface and/or to the part to be cleaned in a simple manner, optionally applying mechanical energy, for example, by rubbing with a cloth or a sponge, and then removing the agent and the oxidatively attacked soil by washing out with water, for example, with the help of a moistened cloth or sponge after a period of time to be determined by the user. In a preferred embodiment of the invention, an inventive agent that can be used in particular as a pretreatment agent is aqueous and fluid and has a pH in the range of pH 1 to pH 12, in particular from pH 5 to pH 11.

The inventive agents preferably contain 0.01 wt % to 0.5 wt %, in particular 0.02 wt % to 0.3 wt % of bleach-activating transition metal complex. Alternatively or optionally also additionally the inventive agent may also contain only one or several ligands which can form a bleach-activating transition metal complex in situ with a transition metal in the washing process. The transition metal may also be present in the washing agent in the form of a salt or a non-bleach-activating complex or it is introduced into the washing process as a component of the process water used for it or via the textile to be cleaned, for example, as a component of the soil to be removed.

The inventive washing and cleaning agents may in principle contain all the known ingredients conventionally used in such agents, in addition to the peroxygen-containing bleach agent, the bleach-activating transition metal complex and/or the ligand, which may faun the bleach-activating transition metal complex in situ, and creatine. The inventive washing agents and cleaning agents may in particular contain builder substances, surface-active surfactants, enzymes, sequestering agents, electrolytes, pH regulators, polymers with special effects such as soil-release polymers, dye transfer inhibitors, graying inhibitors, wrinkle-reducing active ingredients and shape-retaining active ingredients and additional auxiliary substances such as optical brighteners, foam regulators, additional peroxygen activators, dyes and perfumes.

In particular organic peracids and/or peracidic salts of organic acids may be considered as peroxygen compounds suitable for use in the inventive method, in the inventive use and in the inventive agents, such as phthalimido-percaproic acid, perbenzoic acid or salts of diper-dodecane-dioic acid, hydrogen peroxide and inorganic salts that release hydrogen peroxide under the washing conditions, including alkali perborate, alkali percarbonate, alkali persilicate and/or alkali persulfate such as caroate. If solid peroxygen compounds are to be used, they may be used in the form of powders or granules which may also be coated in a manner which is known in principle. The addition of small amounts of known bleach agent stabilizers, for example, phosphonates, borates and/or metaborates and metasilicates as well as magnesium salts such as magnesium sulfate may be expedient. An inventive agent preferably contains 15 wt % to 50 wt %, in particular 18 wt % to 35 wt % peroxygen-containing bleaching agent in particular alkali percarbonate. Alternatively or optionally additionally, hydrogen peroxide may also be produced in the inventive process by an enzymatic system namely an oxidase in combination with its substrate which in a preferred embodiment of the invention is a component of the inventive agent and may partially or preferably completely replace the peroxygen-containing bleach agent in this inventive agent.

In addition to the bleach-activating transition metal complex compound, additional compounds known as bleach activating active ingredients may, if desired, also be used in the inventive agents, in particular conventional bleach activators, i.e., compounds which yield optionally substituted perbenzoic acid and/or peroxocarboxylic acids with 1 to 10 carbon atoms, in particular 2 to 4 carbon atoms under perhydrolysis conditions. Conventional bleach activators which have O- and/or N-acyl groups of the aforementioned number of carbon atoms and/or optionally substituted benzoyl groups are suitable. Polyacylated alkylenediamines in particular tetraacetylethylenediamine (TAED), acylated glycolurils in particular tetraacetylglycoluril (TAGU), acylated triazine derivatives in particular 1,5-diacetyl-2,4-dioxohexahydro-1,3,5-triazine (DADHT), acylated phenyl sulfonates in particular nonanoyloxy- or isononanoyl-oxy-benzene-sulfonate, N-acylated caprolactams or valerolactams, in particular N-acetylcaprolactam, acylated polyvalent alcohols in particular triacetin, ethylene glycol diacetate and 2,5-diacetoxy-2,5-dihydrofuran as well as acetylated sorbitol and mannitol and acylated sugar derivatives in particular pentaacetyl glucose (PAG), pentaacetyl fructose, tetraacetyl xylose and octaacetyl lactose as well as acetylated optionally N-alkylated glucamine and gluconolactone. Nitriles which form perimidic acids under perhydrolysis conditions such as 4-morpholine carbonitrile or ammonium group-carrying acetonitriles may also be used. However, the inventive agents are preferably free of such conventional bleach activators.

The inventive agents may contain one or more surfactants, and in particular anionic surfactants, nonionic surfactants and mixtures of those may be considered. Suitable nonionic surfactants include in particular alkyl glycosides and ethoxylation and/or propoxylation products of alkyl glycosides or linear or branched alcohols each with 12 to 18 carbon atoms in the alkyl part and 3 to 20, preferably 4 to 10 alkyl ether groups. In addition, corresponding ethoxylation and/or propoxylation products of N-alkylamines, vicinal diols, fatty acid esters and fatty acid amides which correspond to the aforementioned long-chain alcohol derivatives with regard to the alkyl part as well as alkyl phenols with 5 to 12 carbon atoms in the alkyl part may also be used.

Suitable anionic surfactants include in particular soaps and those containing sulfate or sulfonate groups with preferable alkali ions as cations. Soaps that may be used are preferable the alkali salts of saturated or unsaturated fatty acids with 12 to 18 carbon atoms. Such fatty acids may also be used in incompletely neutralized form. The usable surfactants of the sulfate type include the salts of sulfuric acid hemiesters of fatty alcohols with 12 to 18 carbon atoms and the sulfation products of the aforementioned nonionic surfactants with a low degree of ethoxylation. The usable surfactants of the sulfonate type include linear alkylbenzene sulfonates with 9 to 14 carbon atoms in the alkyl part, alkane sulfonates with 12 to 18 carbon atoms and olefin sulfonates with 12 to 18 carbon atoms which are formed by the reaction of corresponding monoolefins with sulfur trioxide as well as α-sulfofatty acid esters which are formed in sulfonation of fatty acid methyl or ethyl esters.

Such surfactants are present in the inventive cleaning agents or washing agents in amounts of preferably 5 wt % to 50 wt %, in particular 8 wt % to 30 wt %.

An inventive agent preferably contains at least one water-soluble and/or water-insoluble organic and/or inorganic builder. The water-soluble organic builder substances include polycarboxylic acids in particular citric acid and sugar acids, monomeric and polymeric aminopolycarboxylic acids in particular methyl glycine diacetic acid, nitrolotriacetic acid, ethylenediamine-N,N′-disuccinic acid and ethylenediamine tetraacetic acid as well as polyaspartic acid, polyphosphonic acids in particular aminotris(methylenephosphonic acid), ethylenediamine tetrakis(methylenephosphonic acid) and 1-hydroxyethane-1,1-diphosphonic acid, polymeric hydroxyl compounds, such as dextrin and polymeric (poly)carboxylic acids, in particular the polycarboxylates accessible by oxidation of polysaccharides and/or dextrins, polymeric acrylic acids, methacrylic acids, maleic acids and copolymers thereof, which may also contain small amounts of polymerizable substances without any carboxylic acid functionality polymerized into them. The relative molecular weight of the homopolymers of unsaturated carboxylic acids is generally between 5000 and 200,000, while that of the copolymers is between 2000 and 200,000, preferably from 50,000 to 120,000, each based on free acid. An especially preferred acrylic acid-maleic acid copolymer has a relative molecular weight of 50,000 to 100,000. Suitable, although less preferred, compounds of this class include copolymers of acrylic acid or methacrylic acid with vinyl ethers such as vinyl methyl ethers, vinyl esters, ethylene, propylene and styrene in which the amount of acid is at least 50 wt %. The water-soluble organic builder substances may also be terpolymers which contain as monomers two unsaturated acids and/or their salts and as the third monomer vinyl alcohol and/or an esterified vinyl alcohol or a carbohydrate. The first acetic monomer and/or its salt is derived from a monoethylenically unsaturated C₃-C₈ carboxylic acid and preferably from a C₃-C₄ monocarboxylic acid in particular (meth)acrylic acid. The second acidic monomer and/or its salt may be a derivative of a C₄-C₈ dicarboxylic acid, where maleic acid is especially preferred, and/or a derivative of an alkylsulfonic acid which is substituted in position 2 with an alkyl or aryl radical. Such polymers usually have a relative molecular weight between 1000 and 200,000. Additional preferred copolymers include those having preferably acrolein and acrylic acid/acrylic acid salt and/or vinyl acetate as monomers. All the aforementioned acids are usually used in the form of their water-soluble salts in particular their alkali salts.

Such organic builder substances may if desired be present in amounts of up to 40 wt %, in particular up to 25 wt % and preferably from 1 wt % to 8 wt %.

Water-soluble inorganic builder materials that may be considered include in particular polymeric alkali phosphates which may be present in the form of their alkaline, neutral or acidic sodium or potassium salts. Examples include tetrasodium diphosphate, disodium dihydrogen diphosphate, pentasodium triphosphate, so-called sodium hexametaphosphate and the corresponding potassium salts and/or mixtures of sodium and potassium salts. Water-insoluble, water-dispersible inorganic builder materials used include in particular crystalline or amorphous alkali aluminosilicates in amounts of up to 50 wt %, preferably no more than 40 wt %, and from 1 wt % to 5 wt % in liquid agents in particular. Of these, the crystalline sodium aluminosilicates in washing agent quality, in particular zeolite A, P and optionally X are preferred. Quantities near the aforementioned upper limit are preferably used in solid particulate agents. Suitable aluminosilicates in particular do not have any particles with a grain size of greater than 30 μm and preferably consist of at least 80 wt % particles less than 10 μm in size. Their calcium binding capacity, which can be determined according to the specifications of German Patent DE 24 12 837, is usually in the range of 100 to 200 mg CaO per gram.

Suitable substitutes and/or partial substitutes for the aforementioned aluminosilicate include crystalline alkali silicates which may be present alone or in mixture with amorphous silicates. The alkali silicates which can be used as builders in the inventive agents preferably have a molar ratio of alkali oxide to SiO₂ of less than 0.95, in particular 1:1.1 to 1:12 and may be in amorphous or crystalline form. Preferred alkali silicates include the sodium silicates in particular the amorphous sodium silicates with a molar ratio of Na₂O:SiO₂ of 1:2 to 1:2.8. Crystalline layered silicates of the general formula Na₂SiₓO₂ₓ₊₁≅yH₂O, where x, the so-called modulus, is a number from 1.9 to 4, and y is a number from 0 to 20, and preferred values for x are 2, 3 or 4, are preferably used as crystalline silicates, which may be present alone or in mixture with amorphous silicates. Preferred crystalline layered silicates include those in which x in the aforementioned general formula assumes the values of 2 or 3. In particular both β- and δ-sodium disilicates (Na₂Si₂O₅≅yH₂O) are preferred. Practically anhydrous crystalline alkali silicates of the aforementioned general formula produced from amorphous alkali silicates, where x is a number from 1.9 to 2.1, may be used in the inventive agents. In another preferred embodiment of inventive agents, a crystalline sodium layered silicate with a modulus of 2 to 3 is used such as that which can be produced from sand and sodium carbonate. Crystalline sodium silicates with a modulus in the range of 1.9 to 3.5 are used in another preferred embodiment of the inventive agents. In a preferred embodiment of inventive agents, a granular compound of alkali silicate and alkali carbonate is used such as that available commercially under the brand name Nabion® 15. If alkali aluminosilicates in particular a zeolite is also present as an additional builder substance, then the weight ratio of aluminosilicate to silicate, each based on anhydrous active substances, is preferably 1:10 to 10:1. The weight ratio of amorphous alkali silicate to crystalline alkali silicate in agents containing both amorphous and crystalline alkali silicates is preferably 1:2 to 2:1 and in particular 1:1 to 2:1.

Builder substances are preferably present in the inventive washing agents or cleaning agents in amounts of up to 60 wt %, in particular from 5 wt % to 40 wt %, while the inventive disinfectants are preferably free of the builder substances which complex only the components of water hardness and preferably contain no more than 20 wt %, in particular 0.1 to 5 wt % heavy metal complexing substances, preferably from the group comprising amino-polycarboxylic acids, aminopolyphosphonic acids and hydroxypolyphosphonic acids and their water-soluble salts and mixtures thereof.

In a preferred embodiment of the invention, an inventive agent contains a water-soluble builder block. By using the term “builder block” this should express the fact that the agent does not contain any other builder substances than those which are water soluble, i.e., all the builder substances present in the agent are combined in what is characterized as a “block” but at any rate the quantities of substances excluding those stabilizing additives and/or impurities may be present in small amount in the other ingredients of the agents. The term “water soluble” should be understood to mean that the builder block dissolves without leaving a residue at the concentration which results from the use quantity of the agent containing it under the usual conditions. Preferably at least 15 wt % and up to 55 wt %, in particular 25 wt % to 50 wt % water-soluble builder block is present in the inventive agents. This is preferably composed together of the components

a) 5 wt % to 35 wt % citric acid, alkali citrate and/or alkali carbonate, which may be replaced at least proportionally by alkali bicarbonate,

b) up to 10 wt % alkali silicate with a modulus in the range of 1.8 to 2.5,

c) up to 2 wt % phosphonic acid and/or alkali phosphonate,

d) up to 50 wt % alkali phosphate and

e) up to 10 wt % polymeric polycarboxylate,

where the quantities given are also based on the total washing agent and/or cleaning agent. This is also true of all the other quantity information unless explicitly stated otherwise.

In a preferred embodiment of inventive agents the water-soluble builder block contains at least two of the components b), c), d) and e) in amounts greater than 0 wt %.

With regard to component a), in a preferred embodiment of inventive agents, 15 wt % to 25 wt % alkali carbonate, which may be replaced at least proportionately by alkali bicarbonate, and up to 5 wt %, in particular 0.5 wt % to 2.5 wt % citric acid and/or alkali citrate are contained in it. In an alternative embodiment of the inventive agents, 5 wt % to 25 wt %, in particular 5 wt % to 15 wt % citric acid and/or alkali citrate and up to 5 wt %, in particular 1 wt % to 5 wt % alkali carbonate, which may be replaced at least proportionally by alkali bicarbonate, are present as component a). If both alkali carbonate and alkali bicarbonate are present, then component a) contains alkali carbonate and alkali bicarbonate preferably in a weight ratio of 10:1 to 1:1.

With regard to component b), in a preferred embodiment of the inventive agents, 1 wt % to 5 wt % alkali silicate with a modulus in the range of 1.8 to 2.5 may be present.

With regard to component c), in a preferred embodiment of the inventive agents, 0.05 wt % to 1 wt % phosphonic acids and/or alkali phosphonate are present. Of the phosphonic acids, optionally substituted alkyl and aryl phosphonic acids such as, for example, phenyl phosphonic acid are understood which may also contain several phosphonic acid groupings (so-called polyphosphonic acids). They are preferably selected from the hydroxy and/or aminoalkylphosphonic acids and/or their alkali salts, for example, dimethyl-aminomethane diphosphonic acid, 3-aminopropane-1-hydroxy-1,1-diphosphonic acid, 1-amino-1-phenylmethanediphosphonic acid, 1-hydroxyethane-1,1-diphosphonic acid (HEDP), amino-tris(methylenephosphonic acid), and acylated derivatives of phosphorous acid which may also be used in any mixtures.

With regard to component d), in a preferred embodiment of the inventive agents, 15 wt % to 35 wt % alkali phosphate in particular trisodium polyphosphate is present. Alkali phosphate is the umbrella term for the alkali metal salts (in particular sodium and potassium salts) of the various phosphoric acids, and a distinction can be made between metaphosphoric acids (HPO₃)ₙ and orthophosphoric acid H₃PO₄ in addition to higher molecular representatives. The phosphates combine several advantages: they act as alkali carriers, prevent lime deposits on machine parts and/or lime encrustations in fabrics and also contribute toward the cleaning performance. Sodium dihydrogen phosphate NaH₂PO₄ exists as a dihydrate (density 1.91 gcm⁻³, melting point 60° C.) and as a monohydrate (density 2.04 gcm⁻³). Both salts are white powders which are very highly soluble in water, lose their water of crystallization on heating and are converted at 200° C. into the weakly acidic diphosphate (disodium hydrogen diphosphate Na₂H₂P₂O₇), at a higher temperature into sodium trimetaphosphate (Na₃P₃O₉) and Madrell's salt. NaH₂PO₄ gives an acidic reaction and is formed when phosphoric acid is adjusted to a pH of 4.5 with sodium hydroxide solution and the slurry is sprayed. Potassium dihydrogen phosphate (primary or monobasic potassium phosphate, potassium biphosphate KDP), KH₂PO₄, is a white salt of the density 2.33 gcm⁻³, has a melting point of 253° C. (decomposes, forming (KPO₃)ₓ, potassium polyphosphate) and is readily soluble in water. Disodium hydrogen phosphate (secondary sodium phosphate) Na₂HPO₄ is a colorless very readily water-soluble crystalline salt. It exists in an anhydrous form and with 2 mol water (density 2.066 gcm⁻³, water loss at 95° C.), 7 mol water (density 1.68 gcm⁻³, melting point 48° C. with the loss of 5H₂O) and 12 mol water (density 1.52 gcm⁻³, melting point 35° C. with a loss of 5H₂O), becoming anhydrous at 100° C. and, when heated to an even greater extent, developing into the diphosphate Na₄P₂O₇. Disodium hydrogen phosphate is synthesized by neutralizing phosphoric acid with sodium carbonate solution using phenolphthalein as an indicator. Dipotassium hydrogen phosphate (secondary or dibasic potassium phosphate) K₂HPO₄ is an amorphous white salt which is readily soluble in water. Trisodium phosphate, tertiary sodium phosphate, Na₃PO₄ forms colorless crystals which have a density of 1.62 gcm⁻³ as the dodecahydrate and has a melting point of 73-76° C. (decomp), as the decahydrate (corresponding to 19-20% P₂O₅) has a melting point of 100° C. and in anhydrous form (corresponding to 39-40% P₂O₅) has a density of 2.536 gcm⁻³. Trisodium phosphate is readily soluble in water giving an alkaline reaction and is synthesized by evaporating a solution of exactly 1 mol disodium phosphate and 1 mol NaOH. Tripotassium phosphate (tertiary or tribasic potassium phosphate), K₃PO₄ is a white deliquescing granular powder with a density of 2.5 gcm⁻³ and a melting point of 1340° C. and is readily soluble in water and gives an alkaline reaction. It is formed, for example, on heating Thomas slag with coal and potassium sulfate. Despite the higher price, the more readily soluble and therefore highly effective potassium phosphates are often preferred in the cleaning agent industry in comparison with the corresponding sodium compounds. Tetrasodium diphosphate (sodium pyrophosphate), Na₄P₂O₇ exists in an anhydrous form (density 2.534 gcm⁻³, melting point 988° C. also reported as 880° C.) and as a decahydrate (density 1.815-1.836 gcm⁻³, melting point 94° with loss of water). With these substances there are colorless crystals which are soluble in water with an alkaline reaction. Na₄P₂O₇ is formed on heating disodium phosphate to >200° or by reacting phosphoric acid with sodium carbonate in a stoichiometric ratio and dehydrating the solution by spraying. The decahydrate forms complexes with heavy metal salts and substances that make water hard and thereby reduces the hardness of the water. Potassium diphosphate (potassium pyrophosphate) K₄P₂O₇ exists in the form of trihydrate and is a colorless hygroscopic powder with a density of 2.33 gcm⁻⁻³ which is soluble in water in which a 1% solution at 25° C. has a pH of 10.4. By condensation of NaH₂PO₄ and/or KH₂PO₄ higher molecular sodium and potassium phosphate are formed in which cyclic representatives, the sodium and/or potassium metaphosphates and chain type compounds the sodium and/or potassium polyphosphates can be differentiated. A variety of terms are customarily used for the latter in particular: melt or calcinations phosphates, Graham's salt, Kurrol's salt and Madrell's salt. All higher sodium and potassium phosphates are referred to jointly as condensed phosphates. Pentasodium triphosphate Na₅P₃O₁₀ (sodium tripolyphosphate), which is important industrially is a white, nonhygroscopic, water-soluble salt of the general formula NaO—[P(O)(ONa)—O]ₙ—Na where n=3, which is anhydrous or crystallizes with 6H₂O. At room temperature, approx. 17 g will dissolve in 100 g water, at 60° approx. 20 g will dissolve and at 100° approx. 32 g of the salt which is free of water of crystallization will dissolve. After heating the solution at 100° C. for 2 hours, approx. 8% orthophosphate and 15% diphosphate are formed by hydrolysis. In the synthesis of pentasodium triphosphate, phosphoric acid is reacted with sodium carbonate solution or sodium hydroxide solution in a stoichiometric ratio and the solution is dehydrated by spraying. Like Graham's salt and sodium diphosphate, pentasodium triphosphate will dissolve many insoluble metal compounds (including lime soaps, etc.). Pentapotassium triphosphate K₅P₃O₁₀ (potassium tripolyphosphate) is marketed, for example, in the form of a 50 wt % solution (>23% P₂O₅, 25% K₂O). The potassium polyphosphates are used widely in the washing agent and cleaning agent industry. In addition there are also sodium potassium tripolyphosphates which can also be used within the scope of the present invention. These are formed, for example, when sodium trimetaphosphate is hydrolyzed with KOH:

(NaPO₃)₃+2KOH→Na₃K₂P₃O₁₀+H₂O

These can be used exactly the same according to the invention as sodium tripolyphosphate, potassium tripolyphosphate or mixtures of these two; mixtures of sodium tripolyphosphate and sodium potassium tripolyphosphate or mixtures of potassium tripolyphosphate and sodium potassium tripolyphosphate or mixtures of sodium tripolyphosphate and potassium tripolyphosphate and sodium potassium tripolyphosphate can also be used according to the invention.

With regard to component e), in a preferred embodiment of the inventive agents, 1.5 wt % to 5 wt % polymeric polycarboxylate, selected in particular from the polymerization products and/or copolymerization products of acrylic acid, methacrylic acid and/or maleic acid is present. Of these, the homopolymers of acrylic acid are preferred, and of these in turn those having an average molecular weight in the range of 5000 D to 15,000 D (PA standard) are particularly preferred.

In addition to the above-mentioned oxidase, enzymes that may be used in these agents also include those from the class of proteases, lipases, cutinases, amylases, pullulanases, mannanases, cellulases, hemicellulases, xylanases and peroxidases as well as mixtures thereof, for example, proteases such as BLAP®, Optimase®, Opticlean®, Maxacal®, Maxapem®, Alcalase®, Esperase®, Savinase®, Durazym® and/or Purafect® OxP, amylases such as Termamyl®, Amylase-LT®, Maxamyl®, Duramyl® and/or Purafect® OxAm, lipases such as Lipolase®, Lipomax®, Lumafast® and/or Lipozym®, cellulases such as Celluzyme® and/or Carezyme®. Enzymatic active ingredients obtained from fungi or bacteria are especially suitable such as Bacillus subtilis, Bacillus licheniformis, Streptomyces griseus, Humicola lanuginose, Humicola insolens, Pseudomonas pseudoalcaligenes or Pseudomonas cepacia. The enzymes which may optionally be used may be adsorbed onto carrier substances and/or embedded into coating substances to protect them from premature inactivation. They are present in the inventive washing agents, cleaning agents and disinfectants preferably in amounts up to 10 wt %, in particular from 0.2 wt % to 2 wt %, whereby enzymes stabilized against oxidative degradation are especially preferred for use here.

In a preferred embodiment of the invention, the agent contains 5 wt % to 50 wt %, in particular 8-30 wt % anionic and/or nonionic surfactant, up to 60 wt %, in particular 5-40 wt % builder substance and 0.2 wt % to 2 wt % enzymes selected from the proteases, lipases, cutinases, amylases, pullulanases, mannanases, cellulases, oxidases and peroxidases as well as mixtures thereof.

To adjust a desired pH, which does not result automatically from mixing the other components when adding water, the inventive agents may also acids which are compatible with the system and are environmentally friendly, in particular citric acid, acetic acid, tartaric acid, malic acid, lactic acid, glycolic acid, succinic acid, glutaric acid and/or adipic acid but also mineral acids in particular sulfuric acid or bases in particular ammonium or alkali hydroxides. Such pH regulators are preferably present in the inventive agents in amounts of no more than 20 wt %, in particular 1.2 wt % to 17 wt %.

Soil release-enabling polymers, often referred to as “soil release” active ingredients or as “soil repellents” because of their ability to finish the treated surface, for example, the fiber, to make it dirt repellant include, for example, nonionic or cationic cellulose derivatives. The soil release polymers which are polyester active in particular include copolyesters of dicarboxylic acids, for example, adipic acid, phthalic acid or terephthalic acid, diols, for example, ethylene glycol or propylene glycol and polydiols, for example, polyethylene glycol or polypropylene glycol. The preferred soil release polyesters for use here include those compounds which are formally accessible by esterification of two monomer parts, where the first monomer is a dicarboxylic acid HOOC-Ph-COOH and the second monomer is a diol HO—(CHR²¹)ₐOH which may also be present as a polymeric diol H—(O—(CHR²¹)ₐ)_{b}OH, where Ph denotes an o-, m- or p-phenylene radical which may have 1 to 4 substituents selected from alkyl radicals with 1 to 22 carbon atoms, sulfonic acid groups, carboxyl groups and mixtures thereof, R²¹ is hydrogen, an alkyl radical with 1 to 22 carbon atoms and mixtures thereof, a is a number from 2 to 6 and b is a number from 1 to 300. Preferably the polyesters obtainable from these contain both monomer diol units O—(CHR²¹)ₐO as well as polymer diol units (O—(CHR²¹)ₐ)_{b}O. The molar ratio of monomer diol units to polymer diol units is preferably 100:1 to 1:100 in particular 10:1 to 1:10. In the polymer diol units the degree of polymerization b is preferably in the range of 4 to 200 in particular 12 to 140. The molecular weight and/or the average molecular weight or the maximum of the molecular weight distribution of preferred soil release polyesters is in the range of 250 to 100,000, in particular from 500 to 50,000. The acid on which the Ph radical is based is preferably selected from terephthalic acid, isophthalic acid, phthalic acid, trimellitic acid, mellitic acid, the isomers of sulfophthalic acid, sulfoisophthalic acid and sulfoterephthalic acid as well as mixtures thereof. If their acid groups are not part of the ester bonds in the polymer, they are preferably in salt form, in particular as the alkali or ammonium salt. Of these the sodium and potassium salts are especially preferred. If desired, instead of the monomer HOOC-Ph-COOH, small amounts in particular no more than 10 mol % based on the amount of Ph with the meaning given above, other acids having at least two carboxyl groups may also be present in the soil release polyester. These include, for example, alkylene and alkenylene dicarboxylic acids such as malonic acid, succinic acid, fumaric acid, maleic acid, glutaric acid, adipic acid, pimelic acid, suberic acid, azelaic acid and sebacic acid. The most preferred diols HO—(CHR²¹)ₐOH include those in which R²¹ is hydrogen and a is a number from 2 to 6 and those in which a has the value 2 and R¹¹ is selected from hydrogen and the alkyl radicals with 1 to 10 in particular 1 to 3 carbon atoms. Of the diols mentioned last, those of the formula HO—CH₂—CHR¹¹—OH in which R¹¹ has the meaning given above are especially preferred. Examples of diol components include ethylene glycol, 1,2-propylene glycol, 1,3-propylene glycol, 1,4-butanediol, 1,5-pentanediol, 1,6-hexanediol, 1,8-octanediol, 1,2-decanediol, 1,2-dodecanediol and neopentyl glycol. Of the polymeric diols, polyethylene glycol with an average molecular weight in the range of 1000 to 6000 is especially preferred. If desired, these polyesters may also be end group capped, whereby alkyl groups with 1 to 22 carbon atoms and esters of monocarboxylic acids may be considered as end groups. The end groups bound by ester bonds may be based on alkyl, alkenyl and aryl monocarboxylic acids with 5 to 32 carbon atoms, in particular 5 to 18 carbon atoms. These include valeric acid, caproic acid, enanthic acid, caprylic acid, pelargonic acid, capric acid, undecanoic acid, undecenoic acid, lauric acid, lauroleic acid, tridecanoic acid, myristic acid, myristoleic acid, pentadecanoic acid, palmitic acid, stearic acid, petroselinic acid, petroselaidic acid, oleic acid, linoleic acid, linolaideic acid, linolenic acid, elaostearic acid, arachic acid, gadoleic acid, arachidonic acid, behenic acid, erucaic acid, brassidic acid, clupanodonic acid, lignoceric acid, cerotinic acid, melissic acid, benzoic acid which may have 1 to 5 substituents with a total of up to 25 carbon atoms, in particular 1 to 12 carbon atoms, for example, tert-butyl benzoic acid. The end groups may also be based on hydroxymonocarboxylic acids with 5 to 22 carbon atoms including, for example, hydroxyvaleric acid, hydroxycaproic acid, ricinoleic acid, their hydrogenation product hydroxystearic acid as well as o-, m- and p-hydroxybenzoic acid. The hydromonocarboxylic acids may in turn be linked together by their hydroxyl group and their carboxyl group and may thus be present several times in one end group. The number of hydroxymonocarboxylic acid units per end group, i.e., their degree of oligomerization is preferably in the range of 1 to 50 in particular 1 to 10. In a preferred embodiment of the invention, polymers of ethylene terephthalate and polyethylene oxide terephthalate in which the polyethylene glycol units have molecular weights of 750 to 5000 and the molar ratio of ethylene terephthalate to polyethylene oxide terephthalate is 50:50 to 90:10 may be used alone or in combination with cellulose derivatives.

The dye transfer inhibitors which may be considered for use in the inventive agents for washing textiles include in particular polyvinylpyrrolidones, polyvinylimidazoles, polymeric N-oxides such as poly(vinylpyridine-N-oxide) and copolymers of vinylpyrrolidone with vinylimidazole and optionally other monomers.

The inventive agents for use in washing textiles may contain antiwrinkle agents because textile sheeting, in particular of rayon, wool, cotton and blends thereof may tend to wrinkle because the individual fibers are sensitive to bending, folding, pressing and squeezing across the direction of the fiber. These include, for example, synthetic products based on fatty acids, fatty acid esters, fatty acid amides, alkylol esters, alkylol amides or fatty alcohols, mostly reacted with ethylene oxide, or products based on lecithin or modified phosphoric acid esters.

Graying inhibitors have the function of keeping the soil released from the hard surface and in particular from the textile fiber suspended in the solution. Water soluble colloids usually of an organic nature are suitable for this purpose, for example, starch, glue, gelatin, salts of ether carboxylic acids or ether sulfonic acids of starch or cellulose or salts of acidic sulfuric acid esters of cellulose or of starch. Polyamides containing water-soluble acidic groups are also suitable for this purpose. In addition, starch derivatives other than those mentioned above may also be used, for example, aldehyde starches. Cellulose ethers such as carboxymethyl cellulose (Na salt), methyl cellulose, hydroxyalkyl cellulose and mixed ethers such as methylhydroxyethyl cellulose, methylhydroxypropyl cellulose, methylcarboxymethyl cellulose and mixtures thereof, for example, in amounts of 0.1 to 5 wt %, based on the agent, are preferred.

The agents may contain optical brighteners, in particular derivatives of diaminostilbene disulfonic acid and/or their alkali metal salts. For example, salts of 4,4′-bis(2-anilino-4-morpholino-1,3,5-triazinyl-6-amino)stilbene-2,2′-disulfonic acid or compounds of similar structure containing instead of the morpholino group a diethanolamine group, a methylamino group, an anilino group or a 2 methoxyethylamino group are also suitable. In addition, brighteners of the substituted diphenylstyryl type may also be present, for example, the alkali salts of 4,4′-bis(2-sulfostyryl)diphenyls, 4,4′-bis(4-chloro-3-sulfostyryl)diphenyls or 4 (4 chlorostyryl)-4′-(2-sulfostyryl)diphenyls. Mixtures of the aforementioned optical brighteners may also be used.

In particular for use in machine washing and cleaning processes, it may be advantageous to add the usual foam inhibitors to these agents. Suitable foam inhibitors include, for example, soaps of natural or synthetic origin containing a large amount of C₁₈-C₂₄ fatty acids. Suitable nonsurfactant foam inhibitors include, for example, organopolysiloxanes and mixtures thereof with microfine optionally silanized silicic acid as well as paraffins, waxes, microcrystalline waxes and mixtures thereof with silanized silicic acid or bis-fatty acid alkylenediamides. Mixtures of various foam inhibitors may also be used to advantage, for example, those of silicones, paraffins or waxes. The foam inhibitors in particular foam inhibitors containing silicone and/or paraffin are preferably ground to a granular carrier substance which is soluble and/or dispersible in water. In particular mixtures of paraffins and bistearylethylene-diamide are preferred.

Active ingredients to prevent tarnishing of objects made of silver, so-called silver corrosion inhibitors may also be used in the inventive agents. Preferred silver corrosion inhibitors include organic disulfides, divalent phenols, trivalent phenols, optionally alkyl- or aminoalkyl-substituted triazoles such as benzotriazole as well as cobalt, manganese, titanium, zirconium, hafnium, vanadium or cerium salts and/or complexes in which the aforementioned metals are present in one of the oxidation stages II, III, IV, V or VI.

An inventive agent may also contain the usual antimicrobial active ingredients to potentiate the disinfectant effect with respect to special microbes in addition to containing the aforementioned ingredients. Such antimicrobial additives are preferably contained in the inventive agents in amounts of no more than 10 wt %, in particular from 0.1 wt % to 5 wt %.

An inventive cleaning agent for hard surfaces may also contain abrasive active ingredients in particular from the group comprising powdered quartz, wood dust, plastic powder, chalk and microglass beads as well as mixtures thereof. Abrasive substances are preferably present in the inventive cleaning agents in amounts of no more 20 wt %, in particular 5 wt % to 15 wt %.

### EXAMPLES

Primary washing power and loss of wet tensile strength were tested in a miniaturized washing test. The test was conducted using a simplified washing solution consisting of H₂O₂ and catalyst (1,4,7-trimethyl-1,4,7-triazacyclononane-manganese complex, Mn-Me₃TACN). Solutions of 0.35 g/L H₂O₂ and 5 μmol/L Mn-Me₃TACN and 0 g/L (V1) or 0.5 g/L (M1) creatine in water (3° dH) were used, the pH of the solution having been adjusted by NaOH to pH 10.5.

For measurement of the primary washing power, cotton substrates, which had been provided with a standardized tea soil, were treated for 30 minutes at 20° C. in the respective solutions. The treated fabric substrate was washed out under running water and then dried, and the color was measured. The following table shows the brightness value of the cotton test pieces.

For measurement of the loss of wet tensile strength, cotton strips of a defined width (thread count) were treated 20 times for 45 minutes each at 60° C. in the respective solutions. The strips were dried and immersed in a wetting solution before being torn using a tensile testing machine at a constant tensile test speed. The tear strength of the treated cotton was compared with the tear strength of the untreated cotton, and the results were calculated in loss of wet tensile strength in percentage.

Five determinations were performed for each of the primary washing power and the loss of wet tensile strength. The averages are given in the following table.

| | Bleaching performance | Loss of wet tensile |
|---|---|---|
| | (Y value) | strength (%) |
| V1 | 57.6 | 88 |
| M1 | 56.9 | 75 |

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A method for treatment of material containing cellulose, comprising:
bleaching the material in the presence of a peroxygen-containing bleaching agent, a bleach-activating transition metal complex, and creatine.

2. The method according to claim 1, wherein the bleaching is performed at temperatures in the range of 10° C. to 95° C.

3. The method according to claim 1, wherein the bleaching is performed at a pH in the range of pH 7 to pH 12.

4. The method according to claim 1, wherein the creatine is present at a concentration ranging between 0.001 g/L and 50 g/L.

5. The method according to claim 1, wherein the method is a washing treatment of a textile material containing cellulose performed in a wash bath having a H₂O₂ concentration in the range of 0.001 g/L to 10 g/L.

6. The method according to claim 5, wherein the concentration of the bleach-activating transition metal complex in the wash bath is in the range of 0.1 μmol/L to 50 μmol/L.

7. The method according to claim 1, wherein the bleach-activating transition metal complex is produced from one or more ligands in situ with a transition metal from the bleach-activating transition metal complex.

8. The method according to claim 7, wherein the transition metal is added separately in the form of a salt or a non-bleach-activating complex.

9. The method according to claim 7, wherein the transition metal is introduced as a component of process water used for the bleaching step.

10. The method according to claim 7, wherein the transition metal is introduced as a component of the material containing cellulose.

11. The method according to claim 1, wherein the bleach-activating transition metal complex compound is a metal complex of formula (II)
[LₙMₘXₚ]^{z}Y_{q} (II)
wherein M denotes manganese or iron or mixtures of these metals, which may be present in the oxidation states II, III, IV or V, or in mixtures thereof, n and m, independently of one another, denote integers with a value of 1 to 4, X is a coordinating or bridging species, p is an integer with a value of 0 to 12, Y is a counterion, the type of which depends on the charge z of the complex, which may be positive, zero or negative, q=z/[charge Y] and L is a ligand, which is a macrocyclic organic molecule of the general formula 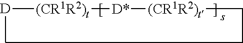
wherein each of the radicals R¹ and R² may be zero, H, alkyl or aryl, optionally substituted; t and t′, independently of one another, are 2 or 3; D and D¹, independently of one another, are N, NR, PR, O or S, where R denotes H, alkyl or aryl, optionally substituted; and s is an integer with a value of 2 to 5, wherein if D=N, one of the heterocarbon compounds bound thereto is unsaturated, which leads to the creation of an N═CR¹ fragment.

12. The method according to claim 1, wherein the complex corresponds to the formula (II), with M=manganese and L=1,4,7-triazacyclononane, 1,4,7-trimethyl-1,4,7-triazacyclononane, 1,5,9-trimethyl-1,5,9-triazacyclododecane or 1,2,4,7-tetra-methyl-1,4,7-triazacyclononane.

13. The method according to claim 1, wherein the bleach-activating transition metal complex compound is a manganese complex of formula (III) 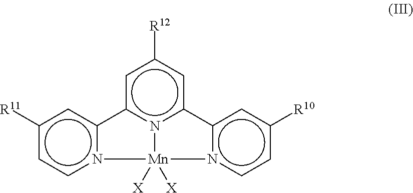
in which R¹⁰ and R¹¹, independently of one another, stand for hydrogen, a C₁₋₁₈ alkyl group, an NR¹³R¹⁴ group, an N⁺R¹³R¹⁴R¹⁵ group or a group 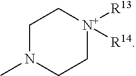
R¹² stands for hydrogen, OH or a C₁₋₁₈ alkyl group, R¹³, R¹⁴ and R¹⁵, independently of one another, stand for hydrogen, a C₁₋₄ alkyl group or C₁₋₄ hydroxyalkyl group, and X stands for a halogen, and A stands for a charge-equalizing anion, which may also be omitted or may be present multiply, depending on its charge and the type and number of other charges, in particular the charge of the central manganese atom.

14. A washing agent which is gentle to textiles, comprising:
a peroxygen-containing bleaching agent,
a bleach-activating transition metal complex, and
creatine.

15. The agent according to claim 14, comprising a transition metal and at least one ligand which combine to form the bleach-activating transition metal complex in situ during the washing process.

16. The agent according to claim 14, wherein the agent is aqueous and liquid and has a pH in the range of pH 1 to pH 12.

17. The agent according to claim 14, wherein the bleach-activating transition metal complex compound is a metal complex of formula (II)
[LₙMₘXₚ]^{z}Y_{q} (II)
wherein M denotes manganese or iron or mixtures of these metals, which may be present in the oxidation states II, III, IV or V, or in mixtures thereof, n and m, independently of one another, denote integers with a value of 1 to 4, X is a coordinating or bridging species, p is an integer with a value of 0 to 12, Y is a counterion, the type of which depends on the charge z of the complex, which may be positive, zero or negative, q=z/[charge Y] and L is a ligand, which is a macrocyclic organic molecule of the general formula 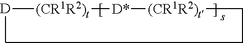
wherein each of the radicals R¹ and R² may be zero, H, alkyl or aryl, optionally substituted; t and t′, independently of one another, are 2 or 3; D and D¹, independently of one another, are N, NR, PR, O or S, where R denotes H, alkyl or aryl, optionally substituted; and s is an integer with a value of 2 to 5, wherein if D=N, one of the heterocarbon compounds bound thereto is unsaturated, which leads to the creation of an N═CR¹ fragment.

18. The method according to claim 17, wherein the complex corresponds to the formula (II), with M=manganese and L=1,4,7-triazacyclononane, 1,4,7-trimethyl-1,4,7-triazacyclononane, 1,5,9-trimethyl-1,5,9-triazacyclododecane or 1,2,4,7-tetra-methyl-1,4,7-triazacyclononane.

19. The method according to claim 14, wherein the bleach-activating transition metal complex compound is a manganese complex of formula (III) 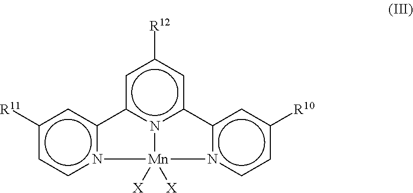
in which R¹⁰ and R¹¹, independently of one another, stand for hydrogen, a C₁₋₁₈ alkyl group, an NR¹³R¹⁴ group, an N⁺R¹³R¹⁴R¹⁵ group or a group 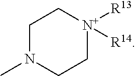
R¹² stands for hydrogen, OH or a C₁₋₁₈ alkyl group, R¹³, R¹⁴ and R¹⁵, independently of one another, stand for hydrogen, a C₁₋₄ alkyl group or C₁₋₄ hydroxyalkyl group, and X stands for a halogen, and A stands for a charge-equalizing anion, which may also be omitted or may be present multiply, depending on its charge and the type and number of other charges, in particular the charge of the central manganese atom.
